(19) United States
(12) Patent Application Publication
(10) Pub. No.: US 2003/0097458 A1
(43) Pub. Date: May 22, 2003

(54) Method and apparatus for encoding, transmitting and decoding an audiovisual stream data

(76) Inventor: Mikael Bourges-Sevenier, Santa Clara, CA (US)

Correspondence Address: GARY CARY WARE & FREIDENRICH LLP, 1755 EMBARCADERO ROAD, PALO ALTO, CA, 94303-3340, US

(21) Appl. No.: 09/970,011

(22) Filed: Oct. 2, 2001

Related U.S. Application Data
(60) Provisional application No. 60/237,740, filed on Oct. 2, 2000.

(51) Int. Cl. G06F 15/16

(52) U.S. Cl. 709/231

(57) ABSTRACT

Four new nodes are proposed for an MPEG 4 audiovisual streaming data. Each of the nodes is encoded as a declarative operation in the scene data field of the MPEG 4 standard. The nodes are physics node, non-linear deformer node, MP4 movie texture node and camera sensor node. The physics node provides realistic behavior to geometry objects operating thereon in accordance with Newton's law. The non-linear deformer node permits a node to be tapered, twisted or bent. The MP4 movie texture node permits a visual element to be displayed in which a rectangular image has all pixels transparent and with some opaque pixels that define the video shape. Finally, a camera sensor node permits a virtual camera to be placed at a particular position of the audiovisual element having an orientation, a field of view and a fall-off parameter.

This application claims the priority of a Provisional Application 60/237,740 filed on Oct. 2, 2000, entitled Nodes for MPEG-4 Systems version 5.

### TECHNICAL FIELD

The present invention relates to a method of encoding an audiovisual scene into an audiovisual stream data as well as a program code capable of executing said method. The present invention also relates to a signal stored on a server for transmitting such audiovisual stream data. Finally, the present invention relates to a method and program code for decoding an audiovisual stream data. More particularly, the present invention relates to a method and program code that improves the encoding, transmitting and decoding of audiovisual stream data through the definition of new nodes.

### BACKGROUND OF THE INVENTION

The encoding, transmission and decoding of audiovisual stream data is well known in the art. For example, the MPEG 4 is a standard that is well known in the art. The MPEG 4 standard provides that an audiovisual scene (which includes audio elements, visual elements, 2D graphic elements and 3D graphic elements) can be parsed into a plurality of audiovisual elements and encoded into an audiovisual stream data, which is stored on a server. The server then transmits the audiovisual stream data over a private or public network, such as the internet, to users who decode the audiovisual stream. The decoding device can consist of a computer, a PDA (personal digital assistant), a cellular phone or a set-up box for a video monitor such as a television device. Using a decoding program code, the received audiovisual stream data is then reconstructed into an audiovisual scene.

The MPEG 4 standard provides that the encoding of the audiovisual elements (and the decoding therefor) is in accordance with a certain standard in which the audiovisual elements interact with one another in accordance with certain node properties. These properties are defined in the scene data portion of the audiovisual stream data. Another portion of the audiovisual stream data is the profile data portion, which indicates to the decoder what the capability of the decoder must be in order to decode the scene data and assemble the audiovisual elements. At the decoder, the scene data is decoded to determine the characteristics of the node that is to be reconstructed using algorithms that are stored in the decoder. The MPEG 4 standard permits developers to create MPEG 4 capabilities that are beyond the accepted capabilities or perform capabilities that are the superset of the MPEG 4 standard. In that connection, the MPEG 4 standard permits different values of the profile data to be created and to be embedded in the profile data portion of the systems stream data. A decoder would decode the profile data portion and from that determine whether or not it is capable of decoding the rest of the audiovisual stream data. Accordingly, it is one of the objects of the present invention to establish new capabilities through new nodes for interaction between audiovisual elements in an audiovisual stream data.

### SUMMARY OF THE INVENTION

In the present invention, a method of encoding an audiovisual scene into an audiovisual stream data comprises defining a profile data for the audiovisual stream data with the profile data determinative of the capability of a decoder necessary to decode the audiovisual stream data. The audiovisual scene is parsed into a plurality of audiovisual elements. A scene data is defined for the plurality of audiovisual elements including a geometry of at least two of the audiovisual elements each having a mass associated therewith with a force acting on the geometry. The profile data, scene data and the plurality of audiovisual elements are assembled into an audiovisual stream data. The present invention also relates to a computer product capable of performing the aforementioned method.

Further, in the present invention an audiovisual stream signal is stored on a server to be transmitted therefrom. The signal comprises a profile control signal determinative of the capability of a decoder necessary to decode the audiovisual stream signal. The audiovisual stream signal also comprises a plurality of audiovisual data signals with each representative of an audiovisual element. Finally, the audiovisual stream signal comprises a scene control signal wherein the scene control signal defines a geometry of at least two audiovisual elements with each audiovisual element having a mass associated therewith with a force acting on the geometry.

Another aspect of the present invention comprises a method of decoding an audiovisual streaming signal to form an audiovisual scene. The method comprises receiving a first portion of the audiovisual stream signal by a decoder with the first portion being a systems signal containing the profile data, determinative of the capability necessary to decode the audiovisual stream signal. The method further comprises determining if the decoder has the capability to decode the audiovisual stream signal based upon the profile data. The decoding is continued in the event the decoder has the capability to decode the audiovisual streaming signal. Otherwise, the method is terminated. A second portion of the audiovisual stream signal is received with the second portion being a plurality of audiovisual signals representing a plurality of audiovisual elements. A third portion of the audiovisual stream signal is received with the third portion being a scene signal with the scene signal defining a geometry of at least two of the plurality of audiovisual elements with each audiovisual element having a mass associated therewith with a force acting on the geometry. The plurality of audiovisual elements including the at least two audiovisual elements are assembled into an audiovisual scene with the geometry being displaced by the force.

In another method of the present invention, the method comprises a method of encoding an audiovisual scene into an audiovisual stream data, a computer product capable of performing the aforementioned method, an audiovisual stream signal stored on the server to be transmitted therefrom, a method of decoding the aforementioned audiovisual stream signal to form an audiovisual scene, and a computer product capable of performing the aforementioned decoding method. The audiovisual stream data comprises a profile data which is determinative of the capability of a decoder necessary to decode the audiovisual stream data, a plurality of audiovisual elements, and a scene data where the scene data defines a non-linear deformation transformation of one of the audiovisual elements.

In another method of the present invention, the method comprises a method of encoding an audiovisual scene into an audiovisual stream data, a computer product capable of performing the aforementioned method, an audiovisual stream signal stored on the server to be transmitted therefrom, a method of decoding the aforementioned audiovisual streaming signal to form an audiovisual scene, and a computer product capable of performing the aforementioned decoding method. The audiovisual streaming signal comprises a systems signal containing profile data which is determinative of the capability necessary to decode the audiovisual stream signal, a plurality of audiovisual signals representing a plurality of audiovisual elements, and a scene signal including a definition of a video shape having a defined shape with some pixels within the defined shape being opaque and all the other pixels within the defined shape being transparent wherein the opaque pixels define the locations where one of the plurality of audiovisual elements is located.

In yet still another method of the present invention, the method comprises a method of encoding an audiovisual scene into an audiovisual streaming data, a computer product capable of performing the aforementioned method, an audiovisual streaming signal stored on the server to be transmitted therefrom, a method of decoding the aforementioned audiovisual streaming signal to form an audiovisual scene, and a computer product capable of performing the aforementioned decoding method. The audiovisual streaming data signal comprises a systems signal containing profile data, determinative of the capability necessary to decode the audiovisual stream signal, a plurality of audiovisual signals representing a plurality of audiovisual elements, and a scene signal defining one of the plurality of audiovisual elements as a camera element having a position, an orientation, and a field of view.

### BRIEF DESCRIPTION OF THE DRAWINGS

FIG. 1 is a schematic block level diagram of a computer capable of performing the encoding method of the present invention along with the necessary program code or software, a server for storing the encoded signals of the present invention, to be transmitted over a private or public network to a number of various devices each capable of decoding the method of the present invention.

FIG. 2 is a schematic diagram of an audiovisual stream data with all of its components as it is encoded, transmitted, and received by a decoder.

FIG. 3 is a schematic block diagram of one novel node of the present invention.

FIG. 4 is a schematic block diagram of another novel node of the present invention.

### DETAILED DESCRIPTION OF THE INVENTION

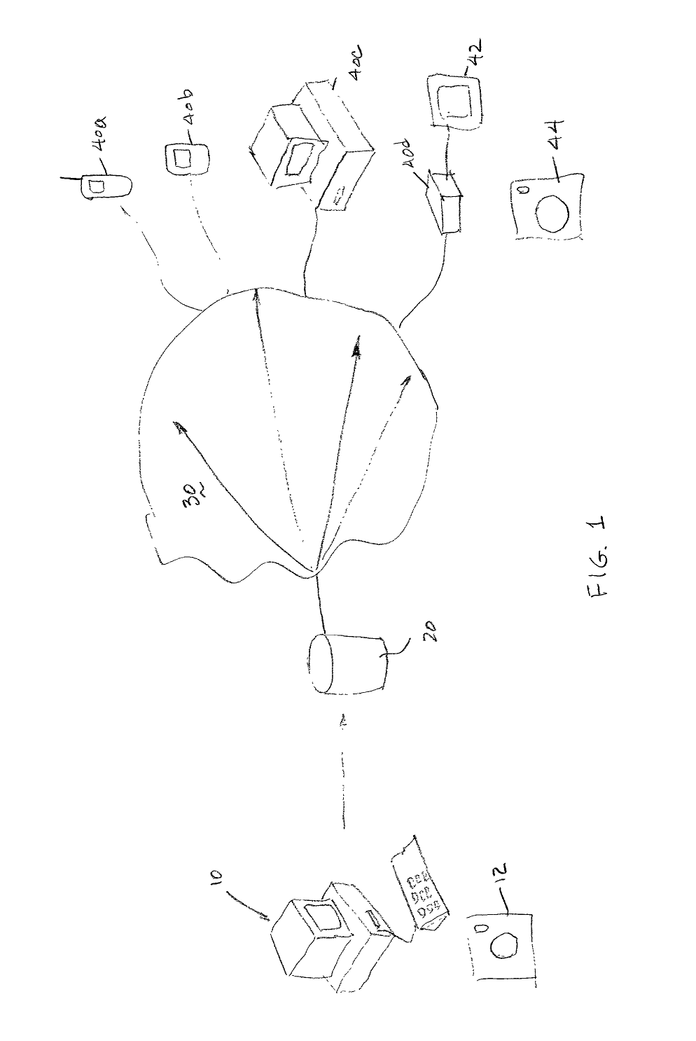

Referring to FIG. 1 there is shown a computer 10 with its associated components of microprocessor, memory, hard drive, monitor, input/output device, and a computer product (software) 12 of the present invention that is capable of performing the encoding method of the present invention. The computer 10 can be a well known workstation, PC or even a mainframe. In the method of encoding of the present invention, an audiovisual scene is converted into an audiovisual streaming data which is then stored on a server 20 for suitable transmission. In a preferred embodiment of the present invention, the method of encoding is in accordance with the MPEG 4 standard with the additional definition of the improved nodes which will be discussed hereinafter. In the MPEG 4 standard, an audiovisual scene is parsed into a plurality of audiovisual elements. As used in the present application, including the claims, the term “audiovisual element” includes audio element, visual element, 2D graphic element, as well as 3D graphic element. The computer 10 with its associated software 12 also can define a profile data for the audiovisual stream data. The profile data is determinative of the capability of a decoder, as discussed hereinafter, which is necessary to decode the audiovisual stream data. Finally, the audiovisual stream data includes a scene data. The scene data defines the interaction among the various audiovisual elements or nodes.

The particular novel interaction between the various audiovisual elements will be discussed hereinafter. The computer 10 along with the computer product 12 assembles the profile data, the scene data, and the plurality of audiovisual elements into an audiovisual streaming data. Once the audiovisual stream data has been assembled, it is stored on a server 20.

The server 20 is capable of being connected to a network, either private or public, such as the internet, for transmission of the audiovisual streaming data thereon. The server 20 transmits over the internet an audiovisual streaming signal which has been encoded by the computer 10 using the computer product 12. The audiovisual streaming signal comprises a systems signal which contains the aforementioned profile data which is determinative of the capability of a decoder necessary to decode the audiovisual streaming signal, a scene control signal which defines the interaction between various audiovisual elements, and a plurality of audiovisual data signals with each representative of an audiovisual element.

The audiovisual streaming signal transmitted over the network 30 can be received by a plurality of decoding devices 40(a-d). These decoding devices 40(a-d) can comprise a cellular phone 40a, a personal digital assistant (PDA) 40b, another computer 40c, or a set up top box 40d connected to an appropriate video monitor or television 42. Each of these decoder devices 40(a-d) executes a computer product 44 which is capable of performing the decoding method described hereinafter.

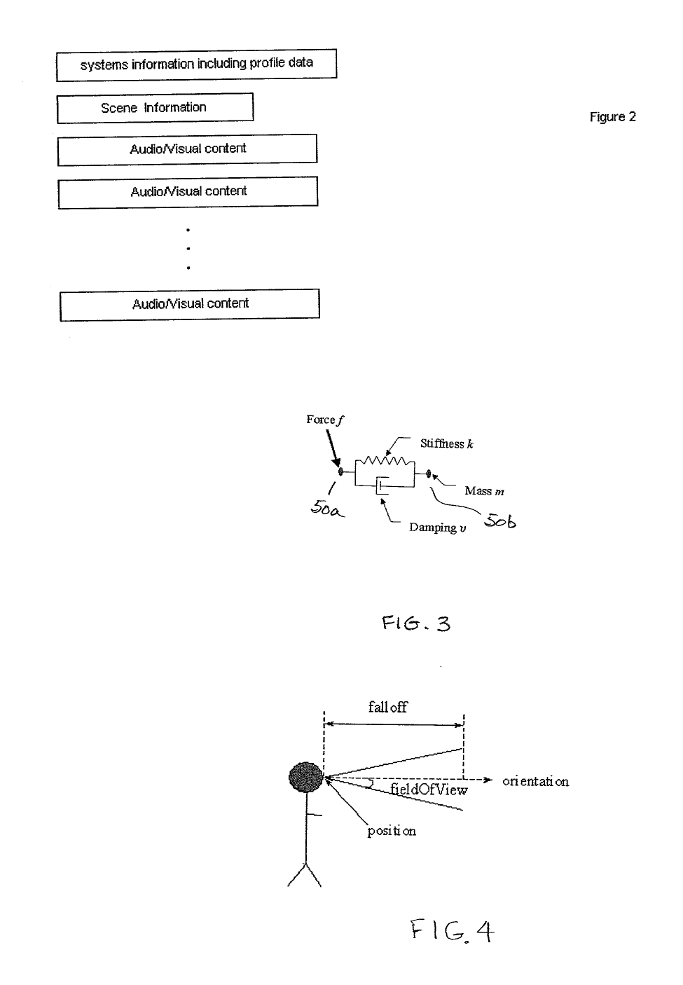

In the decoding method of the present invention, a first portion of an audiovisual streaming signal is received by the decoder 40. As shown in FIG. 2, the first portion is the systems signal containing the profile data which is determinative of the capability that is necessary to decode the audiovisual streaming signal. The decoder 40 uses the systems signal to determine if it has the capability to decode the rest of the audiovisual streaming signal. As previously indicated, the MPEG 4 standard permits audiovisual streaming signals that are supersets of the basic MPEG 4 standard with the systems signal changed to indicate the level of capability that is necessary to decode the audiovisual streaming signal. If the decoder 40 determines that it has the capability to decode the audiovisual streaming signal, as determined by the systems signal, then the method of decoding continues. Otherwise, the decoding method is terminated.

The decoder 40 then receives a second portion of the audiovisual streaming signal. The second portion is a scene signal which is used by the decoder 40 to determine the interaction among the audiovisual elements that follow. The scene signal is stored temporarily into a memory after receipt. Finally, the various audiovisual element signals are then received. The decoder 40 then uses the scene signal to control the various audiovisual element signals to assemble them into an audiovisual scene. Although the foregoing describes the systems signal as being sent (or received) first, followed by the scene signal, followed by the audiovisual signals, it should be clear that this description is of the MPEG 4 standard. The present invention can be used irrespective of the order in which the signals are sent (or received).

As previously stated, the present invention relates to a plurality of new and improved scene data or scene signals which describe new and improved interactions among the various audiovisual elements or nodes. Referring to FIG. 3 there is shown a schematic block level diagram of a new interaction between two audiovisual elements 50a and 50b. The interaction is described as a physics node because it adds a more realistic behavior to the two audiovisual elements 50a and 50b when they are interacting with their environment. This is especially for collision response or behavior. Using the physics tool, one can achieve realistic non-rigid deformation of a geometry. The audiovisual elements 50a and 50b are connected by a line and are modeled as being vertices with mass points, springs and dampers connecting them forming a geometry. A force is applied to the geometry resulting in the geometry being displaced as a result of the force in accordance with Newton's law of f=ma.

The syntax and semantics that is in the scene control data that describes this node is as follows in the MPEG 4 standard.

CLASS Physics {

eventIn MFInt32 set_coordIndex
eventIn MFInt32 set_massIndex
eventIn MFInt32 set_stiffnessIndex
eventIn MFInt32 set_dampingIndex
eventIn MFInt32 set_forceIndex
eventIn MFInt32 set_constraintIndex
exposedField SFCoordinate coord NULL
field MFInt32 coordIndex []
exposedField MFFloat mass [ 0 ]
field MFInt32 massIndex NULL
exposedField MFFloat stiffness []
field MFInt32 stiffnessIndex [ 0 ]
exposedField MFFloat damping []
field MFInt32 dampingIndex NULL
exposedField MFVec3f force [ 0 0 9.81 ]
field MFInt32 forceIndex NULL
exposedField MFContraint constraint []
field MFInt32 constraintIndex NULL

}

The Physics node defines a skeleton made of lines. Each line connects 2 vertices and may have a stiffness and a damping property. Each vertex has a mass. Consequently, if massIndex=NULL, then mass array must contain one mass value for each vertex in the same order as Coordinate.point array in coord field. If massIndex≠NULL, then massIndex contains the index of the mass value for each vertex. In this case, the size of massIndex array should be the same as Coordinate's point array. If mass contains only one value, then all vertices have the same mass (and there is no need to fill massIndex array). Idem for stiffness, damping external forces, and constraints. By default, there is one external force applied to all vertices: the gravity on earth.

Units for these properties should be those defined by the International System of Measurement. Further, it is assumed that the connecting lines are infinitely thin, thus no torsion is possible. In practice, this model is sufficient for most applications, such as collision-response and non-rigid deformation.

Some vertices of the geometry could be attached to a surface and thus can not move. For example, a flag can be attached on one side to its flagpole, or a skin can be attached to vertices of a bone of an avatar. Constraint defines the type of constraint applied to some vertices. The constraintIndex specifies to which vertices the constraint is applied in the order of Coordinate's point in coord field, or −1 if no constraint is applied to a vertex. Constraints may be applied on each of the 6 possible degrees of freedom of a vertex: 3 degrees of translation and 3 degrees of rotation. For example, for a flag fixed on a flagpole, no translation normal to the flagpole is possible.

Once the decoder 40 has determined the interaction between the audiovisual elements as determined from the scene control data, the particular algorithm or manner of implementing the manipulation of the audiovisual elements is up to the decoder, which has previously stored in the particular algorithm to implement the algorithm. Thus, as an example, the following algorithms may be used to implement the physics node:

In a basic mass-and-spring system simulation, the spring forces between the two masses located at positions a and b are given by

$$f = - [ {k}_{s} ( \vert d \vert - r ) + {k}_{d} \frac{\dot{d} ∘ d}{\vert d \vert} ] \frac{d}{\vert d \vert}$$

where f is the force at the location a (or b), d is the vector a-b, d denotes the first derivative (with respect to time) of this vector, r is the rest length of the spring, k, is a spring constant and k_{d} is a damping constant.

Let the constraint function (or vector) be designated as C (as a function of indices). Let Ĉᵢ denote the derivative of the constraint function with respect to the i-th parameter and let \dot{C} be the first derivative of C with respect to time. The force fᵢ, on the i-th mass is then given by,

fᵢ=(−kₛC−k_{d}\dot{C})Ĉi.

A second improvement node of the present invention is a non-linear deformer node. The non-linear deformer node performs three types of deformation operation on an audiovisual element. These include tapering, twisting, and bending.

In the Non-Linear Deformer node, the syntax and semantics that is in the scene control data that describes this node is as follows in the MPEG 4 standard:

NonLinearDeformer {

| | |
|---|---|
| exposedField SFInt32 | type |
| exposedField SFVec3f | axis 0 0 1 |
| exposedField SFFloat | param |
| exposedField MFFloat | extend |
| exposedField SFNode | node |

}

where type is the desired deformation (0: tapering, 1 :twisting, 2:bending). Axis is the axis along which the deformation is performed, param the parameter of the transformation, extend its bounds, and node the geometry node on which the deformation is performed or another Non-Linear Deformer node so to chain the transformations.

| Type | Param | Extend |
|---|---|---|
| 0 tapering | Radius | { relative position, relative radius }* |
| 1 twisting | Angle | Angle min, angle max |
| 2 bending | Curvature | Curvature min, curvature max, y min, |
| | | y max |

For tapering, extend consists of a series of 2 values: the first is the position at which the radius should be. This way a profile can be defined. The relative position along the axis of the transformation in object space: 0% at the beginning, and 100% at the end. The radius is relative to the param and is given in percentage.

An example of the particular algorithm used to achieve the particular deformations is:

### Tapering

To taper an object long the z-axis, x- and y-axes are just scales as a function of z:

(X,Y,Z)=(rx,ry,z) and r=f(z)

where f(z) specifies the rate of scale per unit length along the z-axis and can be a linear or nonlinear tapering profile or function.

### Twisting

To rotate an object through an angle θ about the z-axis:

(X,Y,Z)=(x cos θ−y sin θ, x sin θ+y cos θ, z) and θ=f(z)

where f(z) specifies the rate of twist per unit length along the z-axis.

### Bending

A global linear bend along an axis is a composite transformation comprising a bent region and a region outside the bent region where the deformation is a rotation and a translation. Barr defines a bend region along the y-axis as: yₘᵢₙ≦y≦yₘₐₓ. The radius of curvature of the bend is k⁻¹ and the center of the bend is at y=y₀. The bending angle is: θ=k(y′−y₀), where

$${y}^{′} = \{ \begin{matrix} {y}_{min} & if y \leq {y}_{min} \\ y & if {y}_{min} \leq y < {y}_{max} \\ {y}_{max} & if y \geq {y}_{max}\end{matrix}$$

The deformation is given by

$$\begin{matrix}X = x \\ Y = \{ \begin{matrix} - sin θ ( z - {k}^{- 1} ) + {y}_{0} & {y}_{min} \leq y \leq {y}_{max} \\ - sin θ ( z - {k}^{- 1} ) + {y}_{0} + cos θ ( y - {y}_{min} ) & y < {y}_{min} \\ - sin θ ( z - {k}^{- 1} ) + {y}_{0} + cos θ ( y - {y}_{max} ) & y > {y}_{max}\end{matrix} \\ Z = \{ \begin{matrix} cos θ ( z - {k}^{- 1} ) + {k}^{- 1} & {y}_{min} \leq y \leq {y}_{max} \\ cos θ ( z - {k}^{- 1} ) + {k}^{- 1} + sin θ ( y - {y}_{min} ) & y < {y}_{min} \\ cos θ ( z - {k}^{- 1} ) + {k}^{- 1} + sin θ ( y - {y}_{max} ) & y > {y}_{max}\end{matrix}\end{matrix}$$

A third new node for the scene data of the present invention is a MP4MovieTexture node. In this node, video shapes are sent as separate video elements for an object descriptor. Upon decoding, each shape is a rectangular image with all pixels transparent and some pixels opaque. Where the pixels are opaque, the video shape is defined. The resulting texture is a set of images applied in the order of the elementary streams.

The syntax and semantics that is in the scene control data that describes this node is as follows in the MPEG 4 standard:

CLASS MP4MovieTexture : MovieTexture [

| eventOut | MFImage | images | NULL |
|---|---|---|---|
| eventIn | SFInt32 | selected | −1 |

] {}

images is an array of images (in the order of the elementary streams in the object descriptor) in the MPEG-4 Video stream. This array can change dynamically over time. Each image is a RGBA image: its size is the bounding box of the shape with transparent pixels around the shape and opaque ones inside the shape.

The resulting texture is made of a set of images applied in the order of the elementary at streams. This texture is then mapped onto a geometry object in order to define a shape. Suppose we have a TouchSensor attached to a shape. When the user touches the shape, the TouchSensor a generates an event.

If the texture map is a MP4 Movie Texture, the intersection algorithm should determine if the pixel at the intersection of the pointing device and the geometry is transparent or opaque. If it is opaque, the MP4 Movie Texture sends the index of image the pixel belongs to and the TouchSensor sends touchTime and isActive events. If the pixel is transparent, there is no selection: no selected event is generated from the MP4MovieTexture node and no event from the TouchSensor node.

Referring to FIG. 4 there is shown a schematic description of the CameraSensor node that is another improved node of a scene data of the present invention. The camera sensor node permits an audiovisual element to act as a virtual camera having the parameters of location, orientation, and field of view. Once these parameters are specified, any other audiovisual element entering into the field of view is displayed as if it were generated by the virtual camera node. Another parameter is the fall off parameter, which defines the range at which audiovisual elements are visible in the field of view.

The syntax and semantics that is in the scene control data that describes this node is as follows in the MPEG 4 standard:

CameraSensor : Viewpoint {

| | | | |
|---|---|---|---|
| exposedField | SFFloat | falloff | 0 |
| exposedField | SFBool | enabled | TRUE |
| eventOut | SFTime | enterTime | |
| eventOut | SFTime | exitTime | |
| eventOut | SFBool | isActive | |

}

where the parameters of position, field of view, and orientation are inherited from the Viewpoint node. The falloff is the distance at which the camera sensor cannot see anymore. This parameter defines the height or the depth of the cone from the virtual camera. The width and the height of the cone are defined according to the parent Viewpoint node's fieldOfView parameter. enterTime outputs an event when an object cross the cone of view. isActive TRUE is generated when an object enters the cone and enabled is TRUE. exitTime outputs an event when the object leaves the cone of view. isActive=FALSE is generated is subsequently generated.

It should be recognized that although the present invention has been described as for use with audiovisual streaming data, it is not so limited. Thus, for example, the present invention can also be used where the entire audiovisual data is encoded, transmitted, and downloaded, decoded, and stored locally for subsequent playback.

What is claimed is:

1. A method of encoding an audiovisual scene into an audiovisual stream data, said method comprising:
defining a profile data for said audiovisual stream data, said profile data determinative of the capability of a decoder necessary to decode said audiovisual stream data;
parsing said audiovisual scene into a plurality of audiovisual elements;
defining a scene data for said plurality of audiovisual elements; wherein said scene data defines a geometry of at least two of said audiovisual elements, each having a mass associated therewith with a force acting on said geometry; and
assembling said profile data, said scene data, and said plurality of audiovisual elements into an audiovisual stream data.

2. The method of claim 1 wherein said geometry has a stiffness parameter associated therewith.

3. The method of claim 2 wherein said geometry has a damping parameter associated therewith.

4. The method of claim 3 wherein said at least two of said audiovisual elements of said geometry are displaced by said force in accordance with Newton's law.

5. A computer product comprising:
a computer usable medium having computer readable program code embodied therein for use with a computer for generating an audiovisual stream data, said computer readable program code comprising:
computer readable program code configured to cause said computer to define a profile for said audiovisual stream data, said profile determinative of the capability of a decoder necessary to decode said audiovisual stream data;
computer readable program code configured to cause said computer to parse an audiovisual scene into a plurality of audiovisual elements;
computer readable program code configured to cause said computer to define a scene for said plurality of audiovisual elements; wherein said scene defines a geometry of at least two of said audiovisual elements, each having a mass associated therewith with a force acting on said geometry; and
computer readable program code configured to cause said computer to assemble said profile, said scene, and said plurality of audiovisual elements into said audiovisual stream data.

6. An audiovisual stream signal stored on a server to be transmitted therefrom, said signal comprising:
a profile control signal determinative of the capability of a decoder necessary to decode said audiovisual stream signal;
a plurality of audiovisual data signals, each representative of an audiovisual element; and
a scene control signal, wherein said scene control signal defines a geometry of at least two audiovisual elements, each audiovisual element having a mass associated therewith with a force acting on said geometry.

7. A method of decoding an audiovisual streaming signal to form an audiovisual scene, said method comprising:
receiving a first portion of said audiovisual stream signal by a decoder, said first portion being a profile signal determinative of the capability necessary to decode said audiovisual stream signal;
determining if said decoder has the capability to decode said audiovisual stream signal, based upon said profile signal;
continuing with said decoding in the event said decoder has the capability to decode said audiovisual streaming signal as determined by said profile signal; otherwise terminating the decoding process;
receiving a second portion of said audiovisual stream signal, said second portion being a plurality of audiovisual signals, representing a plurality of audiovisual elements;
receiving a third portion of said audiovisual stream signal, said third portion being a scene signal with said scene signal defining a geometry of at least two of said plurality of audiovisual elements, with each audiovisual element having a mass associated therewith with a force acting on said geometry; and
assembling said plurality of audiovisual elements, including said at least two audiovisual elements, into an audiovisual scene with said geometry being displaced by said force.

8. The method of claim 7 wherein said first portion of said audiovisual stream signal is received first, followed by the third portion of said audiovisual stream signal, followed by the second portion of said audiovisual stream signal.

9. The method of claim 8 wherein said scene signal is stored in memory after receipt.

10. A computer product comprising:
a computer usable medium having computer readable program code embodied therein for use with a computer for decoding an audiovisual streaming signal to form an audiovisual scene, said computer readable program code comprising:
computer readable program code configured to cause said computer to receive a first portion of said audiovisual stream signal by a decoder, said first portion being a profile signal determinative of the capability necessary to decode said audiovisual stream signal;
computer readable program code configured to cause said computer to determine if said decoder has the capability to decode said audiovisual stream signal, based upon said profile signal;
computer readable program code configured to cause said computer to continue with said decoding in the event said decoder has the capability to decode said audiovisual streaming signal as determined by said profile signal; otherwise terminating the decoding process;
computer readable program code configured to cause said computer to receive a second portion of said audiovisual stream signal, said second portion being a plurality of audiovisual signals, representing a plurality of audiovisual elements;
computer readable program code configured to cause said computer to receive a third portion of said audiovisual stream signal, said third portion being a scene signal with said scene signal defining a geometry of at least two of said plurality of audiovisual elements, with each audiovisual element having a mass associated therewith with a force acting on said geometry; and
computer readable program code configured to cause said computer to assemble said plurality of audiovisual elements, including said at least two audiovisual elements, into an audiovisual scene with said geometry being displaced by said force.

11. A method of encoding an audiovisual scene into an audiovisual stream data, said method comprising:
defining a profile data for said audiovisual stream data, said profile data determinative of the capability of a decoder necessary to decode said audiovisual stream data;
parsing said audiovisual scene into a plurality of audiovisual elements;
defining a scene data for said plurality of audiovisual elements; wherein said scene data defines a non-linear deformation transformation of one of said audiovisual elements; and
assembling said profile data, said scene data, and said plurality of audiovisual elements into an audiovisual stream data.

12. The method of claim 11 wherein said non-linear deformation transformation is a tapering transformation.

13. The method of claim 11 wherein said non-linear deformation transformation is a twisting transformation.

14. The method of claim 11 wherein said non-linear deformation transformation is a bending transformation.

15. A computer product comprising:
a computer usable medium having computer readable program code embodied therein for use with a computer for generating an audiovisual stream data, said computer readable program code comprising:
computer readable program code configured to cause said computer to define a profile for said audiovisual stream data, said profile determinative of the capability of a decoder necessary to decode said audiovisual stream data;
computer readable program code configured to cause said computer to parse an audiovisual scene into a plurality of audiovisual elements;
computer readable program code configured to cause said computer to define a scene for said plurality of audiovisual elements; wherein said scene defines a non-linear deformation transformation of one of said audiovisual elements; and
computer readable program code configured to cause said computer to assemble said profile, said scene, and said plurality of audiovisual elements into said audiovisual stream data.

16. An audiovisual stream signal stored on a server to be transmitted therefrom, said signal comprising:
a profile control signal determinative of the capability of a decoder necessary to decode said audiovisual stream signal;
a plurality of audiovisual data signals, each representative of an audiovisual element; and
a scene control signal, wherein said scene control signal defines a non-linear deformation transformation of one of said audiovisual elements.

17. A method of decoding an audiovisual streaming signal to form an audiovisual scene, said method comprising:
receiving a first portion of said audiovisual stream signal by a decoder, said first portion being a profile signal determinative of the capability necessary to decode said audiovisual stream signal;
determining if said decoder has the capability to decode said audiovisual stream signal, based upon said profile signal;
continuing with said decoding in the event said decoder has the capability to decode said audiovisual streaming signal as determined by said profile signal; otherwise terminating the decoding process;
receiving a second portion of said audiovisual stream signal, said second portion being a plurality of audiovisual signals, representing a plurality of audiovisual elements;
receiving a third portion of said audiovisual stream signal, said third portion being a scene signal defining a non-linear deformation transformation of one of said audiovisual elements; and
assembling said plurality of audiovisual elements into an audiovisual scene with said non-linear deformation transformation performed on said one audiovisual element.

18. The method of claim 17 wherein said first portion of said audiovisual stream signal is received first, followed by the third portion of said audiovisual stream signal, followed by the second portion of said audiovisual stream signal.

19. The method of claim 18 wherein said scene signal is stored in memory after receipt.

20. A computer product comprising:
a computer usable medium having computer readable program code embodied therein for use with a computer for decoding an audiovisual streaming signal to form an audiovisual scene, said computer readable program code comprising:
computer readable program code configured to cause said computer to receive a first portion of said audiovisual stream signal by a decoder, said first portion being a profile signal determinative of the capability necessary to decode said audiovisual stream signal;
computer readable program code configured to cause said computer to determine if said decoder has the capability to decode said audiovisual stream signal, based upon said profile signal;
computer readable program code configured to cause said computer to continue with said decoding in the event said decoder has the capability to decode said audiovisual streaming signal as determined by said profile signal; otherwise terminating the decoding process;
computer readable program code configured to cause said computer to receive a second portion of said audiovisual stream signal, said second portion being a plurality of audiovisual signals, representing a plurality of audiovisual elements;
computer readable program code configured to cause said computer to receive a third portion of said audiovisual stream signal, said third portion being a scene signal defining a non-linear deformation transformation of one of said audiovisual elements; and
computer readable program code configured to cause said computer to assemble said plurality of audiovisual elements into an audiovisual scene with said non-linear deformation transformation performed on said one audiovisual element.

21. A method of encoding an audiovisual scene into an audiovisual stream data, said method comprising:
defining a profile data for said audiovisual stream data, said profile data determinative of the capability of a decoder necessary to decode said audiovisual stream data;
parsing said audiovisual scene into a plurality of audiovisual elements;
defining a scene data for said plurality of audiovisual elements, wherein said scene data includes a definition of a video shape having a defined shape with some pixels within said defined shape being opaque and all other pixels within said defined shape being transparent, wherein said opaque pixels defining the locations of where one of said plurality of audiovisual elements is located; and
assembling said profile data, said scene data, and said plurality of audiovisual elements into an audiovisual stream data.

22. The method of claim 1 wherein said defined shape is rectangular.

23. A computer product comprising:
a computer usable medium having computer readable program code embodied therein for use with a computer for generating an audiovisual stream data, said computer readable program code comprising:
computer readable program code configured to cause said computer to define a profile for said audiovisual stream data, said profile determinative of the capability of a decoder necessary to decode said audiovisual stream data;
computer readable program code configured to cause said computer to parse an audiovisual scene into a plurality of audiovisual elements;
computer readable program code configured to cause said computer to define a scene for said plurality of audiovisual elements; wherein said scene includes a definition of a video shape having a defined shape with some pixels within said defined shape being opaque and all other pixels within said defined shape being transparent, wherein said opaque pixels defining the locations of where one of said plurality of audiovisual elements is located; and
computer readable program code configured to cause said computer to assemble said profile, said scene, and said plurality of audiovisual elements into said audiovisual stream data.

24. An audiovisual stream signal stored on a server to be transmitted therefrom, said signal comprising:
a profile control signal determinative of the capability of a decoder necessary to decode said audiovisual stream signal;
a plurality of audiovisual data signals, each representative of an audiovisual element; and
a scene control signal, wherein said scene control signal defines a video shape having a defined shape with some pixels within said defined shape being opaque and all other pixels within said defined shape being transparent, wherein said opaque pixels defining the locations of where one of said plurality of audiovisual elements is located.

25. A method of decoding an audiovisual streaming signal to form an audiovisual scene, said method comprising:
receiving a first portion of said audiovisual stream signal by a decoder, said first portion being a profile signal determinative of the capability necessary to decode said audiovisual stream signal;
determining if said decoder has the capability to decode said audiovisual stream signal, based upon said profile signal;
continuing with said decoding in the event said decoder has the capability to decode said audiovisual streaming signal as determined by said profile signal; otherwise terminating the decoding process;
receiving a second portion of said audiovisual stream signal, said second portion being a plurality of audiovisual signals, representing a plurality of audiovisual elements;
receiving a third portion of said audiovisual stream signal, said third portion being a scene signal with said scene signal including a definition of a video shape having a defined shape with some pixels within said defined shape being opaque and all other pixels within said defined shape being transparent, wherein said opaque pixels defining the locations of where one of said plurality of audiovisual elements is located; and
assembling said plurality of audiovisual elements into an audiovisual scene with said one audiovisual element being in said opaque pixels of said defined shape.

26. The method of claim 25 wherein said first portion of said audiovisual stream signal is received first, followed by the third portion of said audiovisual stream signal, followed by the second portion of said audiovisual stream signal.

27. The method of claim 26 wherein said scene signal is stored in memory after receipt.

28. The method of claim 25 wherein said defined shape is rectangular in shape.

29. A computer product comprising:
a computer usable medium having computer readable program code embodied therein for use with a computer for decoding an audiovisual streaming signal to form an audiovisual scene, said computer readable program code comprising:
computer readable program code configured to cause said computer to receive a first portion of said audiovisual stream signal by a decoder, said first portion being a profile signal determinative of the capability necessary to decode said audiovisual stream signal;
computer readable program code configured to cause said computer to determine if said decoder has the capability to decode said audiovisual stream signal, based upon said profile signal;
computer readable program code configured to cause said computer to continue with said decoding in the event said decoder has the capability to decode said audiovisual streaming signal as determined by said profile signal; otherwise terminating the decoding process;
computer readable program code configured to cause said computer to receive a second portion of said audiovisual stream signal, said second portion being a plurality of audiovisual signals, representing a plurality of audiovisual elements;
computer readable program code configured to cause said computer to receive a third portion of said audiovisual stream signal, said third portion being a scene signal with said scene signal including a definition of a video shape having a defined shape with some pixels within said defined shape being opaque and all other pixels within said defined shape being transparent, wherein said opaque pixels defining the locations of where one of said plurality of audiovisual elements is located; and
computer readable program code configured to cause said computer to assemble said plurality of audiovisual elements into an audiovisual scene with said one audiovisual element being in said opaque pixels of said defined shape.

30. The computer product of claim 29 wherein said defined shape is a rectangle.

31. A method of encoding an audiovisual scene into an audiovisual stream data, said method comprising:
defining a profile data for said audiovisual stream data, said profile data determinative of the capability of a decoder necessary to decode said audiovisual stream data;
parsing said audiovisual scene into a plurality of audiovisual elements;
defining a scene data for said plurality of audiovisual elements; wherein said scene data defines one of said plurality of audiovisual elements as a camera element having a position, an orientation, and a field of view; and
assembling said profile data, said scene data, and said plurality of audiovisual elements into an audiovisual stream data.

32. The method of claim 1 wherein said scene data further has a fall off parameter associated said camera element, defining the limit in the field of view of said camera element.

33. The method of claim 2 wherein said scene data further has a time parameter associated therewith, indicating when another audiovisual element enters into the field of view of said camera element.

34. A computer product comprising:
a computer usable medium having computer readable program code embodied therein for use with a computer for generating an audiovisual stream data, said computer readable program code comprising:
computer readable program code configured to cause said computer to define a profile for said audiovisual stream data, said profile determinative of the capability of a decoder necessary to decode said audiovisual stream data;
computer readable program code configured to cause said computer to parse an audiovisual scene into a plurality of audiovisual elements;
computer readable program code configured to cause said computer to define a scene for said plurality of audiovisual elements; wherein said scene defines one of said plurality of audiovisual elements as a camera element having a position, an orientation, and a field of view; and
computer readable program code configured to cause said computer to assemble said profile, said scene, and said plurality of audiovisual elements into said audiovisual stream data.

35. The computer product of claim 34 wherein said scene data further has a fall off parameter associated said camera element, defining the limit in the field of view of said camera element.

36. An audiovisual stream signal stored on a server to be transmitted therefrom, said signal comprising:
a profile control signal determinative of the capability of a decoder necessary to decode said audiovisual stream signal;
a plurality of audiovisual data signals, each representative of an audiovisual element; and
a scene control signal, wherein said scene control signal defines one of said plurality of audiovisual elements as a camera element having a position, an orientation, and a field of view.

37. A method of decoding an audiovisual streaming signal to form an audiovisual scene, said method comprising:
receiving a first portion of said audiovisual stream signal by a decoder, said first portion being a profile signal determinative of the capability necessary to decode said audiovisual stream signal;
determining if said decoder has the capability to decode said audiovisual stream signal, based upon said profile signal;
continuing with said decoding in the event said decoder has the capability to decode said audiovisual streaming signal as determined by said profile signal; otherwise terminating the decoding process;
receiving a second portion of said audiovisual stream signal, said second portion being a plurality of audiovisual signals, representing a plurality of audiovisual elements;
receiving a third portion of said audiovisual stream signal, said third portion being a scene signal including said scene signal defining one of said plurality of audiovisual elements as a camera element having a position, an orientation, and a field of view; and
assembling said plurality of audiovisual elements into an audiovisual scene including a scene defined by said position, said orientation and said field of view of said camera element.

38. The method of claim 37 wherein said first portion of said audiovisual stream signal is received first, followed by the third portion of said audiovisual stream signal, followed by the second portion of said audiovisual stream signal.

39. The method of claim 38 wherein said scene signal is stored in memory after receipt.

40. A computer product comprising:
a computer usable medium having computer readable program code embodied therein for use with a computer for decoding an audiovisual streaming signal to form an audiovisual scene, said computer readable program code comprising:
computer readable program code configured to cause said computer to receive a first portion of said audiovisual stream signal by a decoder, said first portion being a profile signal determinative of the capability necessary to decode said audiovisual stream signal;
computer readable program code configured to cause said computer to determine if said decoder has the capability to decode said audiovisual stream signal, based upon said profile signal;
computer readable program code configured to cause said computer to continue with said decoding in the event said decoder has the capability to decode said audiovisual streaming signal as determined by said profile signal; otherwise terminating the decoding process;
computer readable program code configured to cause said computer to receive a second portion of said audiovisual stream signal, said second portion being a plurality of audiovisual signals, representing a plurality of audiovisual elements;
computer readable program code configured to cause said computer to receive a third portion of said audiovisual stream signal, said third portion being a scene signal with said scene signal defining a geometry of at least two of said plurality of audiovisual elements, with each audiovisual element having a mass associated therewith with a force acting on said geometry; and
computer readable program code configured to cause said computer to assemble said plurality of audiovisual elements into an audiovisual scene including a scene defined by said position, said orientation and said field of view of said camera element.

41. A method of producing realistic non-rigid deformations over a geometry, the method comprising:
defining a geometry made up of at least two vertices;
connecting a first and a second vertex with a line;
defining a stiffness property for the geometry;
defining a damping property for the geometry;
defining a mass for each vertex; and
determining a resulting displacement of the geometry when interacting with an external force.

42. A method of producing complex non-linear global deformations of an object, the method comprising:
defining a geometry of an object;
calculating a complex non-linear deformation transformation;
applying the complex non-linear deformation transformation to the object.

43. The method of claim 42, wherein the complex non-linear deformation transformation is related to a tapering transformation.

44. The method of claim 42, wherein the complex non-linear deformation transformation is related to a twisting transformation.

45. The method of claim 42, wherein the complex non-linear deformation transformation is related to a bending transformation.

46. A method of providing access shape coding feature of an MPEG-4 video stream, the method comprising:
decoding an MPEG-4 video stream; and
accessing individual object descriptors from the decoded MPEG-4 video stream.
